(19) United States
(12) Patent Application Publication
(10) Pub. No.: US 2010/0093927 A1
(43) Pub. Date: Apr. 15, 2010

(54) Polyurethanes with Nonionic Hydrophilic Terminating Groups and Aqueous Dispersions Thereof

(76) Inventor: C. Chad Roberts, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/328,332

(22) Filed: Dec. 4, 2008

Related U.S. Application Data
(60) Provisional application No. 61/007,022, filed on Dec. 10, 2007.

(51) Int. Cl. C08L 75/04

(52) U.S. Cl. 524/591

(57) ABSTRACT

The present invention relates to polyurethanes with nonionic hydrophilic terminating groups and aqueous dispersions thereof. The polyurethanes may be used as freely added materials or as dispersants for particles such as pigments, disperse dyes, pharmaceuticals and other similar particles, the urea termination has nonionic hydrophilic substituents, such as methoxyethyl groups.

### CROSS-REFERENCE TO RELATED APPLICATION

This application claims priority under 35 U.S.C. §119 from U.S. Provisional Application Ser. No. 60/07022 (filed Dec. 10, 2007), the disclosure of which is incorporated by reference herein for all purposes as if fully set forth.

### FIELD OF THE INVENTION

The present invention relates to water-dispersible urea-terminated polyurethanes formed from the reaction of an isocyanate rich polyurethane prepolymer and a nonionic hydrophilic secondary amine, aqueous dispersions of such polyurethanes, dispersants based on the polyurethanes and their use in ink jet inks and their manufacture.

### BACKGROUND OF THE INVENTION

Polyurethanes are materials with a substantial range of physical and chemical properties, and are widely used in a variety of applications such as coatings, adhesives, fibers, foams and elastomers. For many of these applications the polyurethanes are used as organic solvent-based solutions. However, recently environmental concerns have caused solvent-based polyurethanes to be replaced by aqueous dispersions in many applications.

Polyurethane polymers are, for the purposes of the present invention, polymers wherein the polymer backbone contains urethane linkage derived from the reaction of an isocyanate group (from, e.g., a di- or higher-functional monomeric, oligomeric and/or polymeric polyisocyanate) with a hydroxyl group (from, e.g., a di- or higher-functional monomeric, oligomeric and/or polymeric polyol). Such polymers may, in addition to the urethane linkage, also contain other isocyanate-derived linkages such as urea, as well as other types of linkages present in the starting polyisocyanate components and/or polyol components (such as, for example, ester type and ether type linkage).

Polyurethane polymers can be manufactured by a variety of well-known methods, but are often prepared by first making an isocyanate-terminated “prepolymer” from polyols, polyisocyanates and other optional compounds, then chain-extending and/or chain-terminating this prepolymer to obtain a polymer possessing an appropriate molecular weight and other properties for a desired end use. Tri- and higher-functional starting components can be utilized to impart some level of branching and/or crosslinking to the polymer structure (as opposed to simple chain extension).

Polyurethanes have been prepared from diols as disclosed in Statutory Invention Registration US H2113 but with the limitation that the polyurethane has a hydroxyl number greater than 10 and thus the polyurethanes described are not urea terminated. Polyurethanes have also been prepared from polyether diols as disclosed in EP1167466, US2004/0092622 and US2003/0184629 but these polyurethanes are chain extended with di or triamines, which will result in a polyurethane which has been bridged by the di or triamine chain extension. US2004/0229976, in particular, describes the use of water-dispersible polyurethane resins in pigment-dispersed aqueous recording liquid which have at most 2.0 wt % of polyurethane urea in the polyurethane resin.

Aqueous polyurethane dispersions have found application in numerous end uses, including but not limited to pigmented and colorless coatings, textile treatments, paints, printing inks, adhesives and surface finishes. While these previously described polyurethane resins can be additives for various formulations, especially for pigments and pigmented inks for inkjet inks; the formulations are improved in some performance parameters, but other formulation properties are poorer. Thus, there is still a need for polyurethane resins which provide a good balance of properties including improved performance in most of not all of the properties of the formulations. For example, polyurethane resin additives to ink jet inks can improve the smear and water resistance, but these inks are inferior relative to thermal stability and often cannot be used in thermal ink jet devices.

None of the above publications disclose water dispersible urea-terminated ether type polyurethanes based on the terminating urea group being the product of a reaction with a nonionic hydrophilic secondary amine and the isocyanate groups in the polyurethane prepolymer prior to reaction with the nonionic hydrophilic secondary amine. It has been discovered that these novel polyurethanes and dispersions thereof can be added to the formulations as a freely added material and as such behave as a non-interacting resin in the formulation. An additional use of these novel polyurethanes is as a dispersant for particles including pharmaceuticals, pigments, especially pigments for inkjet inks.

### SUMMARY OF THE INVENTION

In one aspect, the present invention relates to a urea terminated polyurethane composition prepared from reactants comprising:

(a) at least one diol

(b) at least one diisocyanate

(c) a hydrophilic reactant selected from the group consisting of (i) mono or diisocyanate containing an ionic or ionizable group, and (ii) isocyanate reactive reactant containing an ionic or ionizable group,

(d) a non-ionic hydrophilic secondary amine chain terminating agent according to structure I or II or combinations of structure I and II,

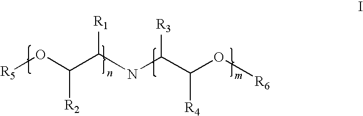

where n, m>0, n+m<10
R₁, R₂, R₃, and R₄ are hydrogen, C₁ to C₅ aliphatic groups and
R₁-R₄ can be bonded to form cyclic substituents
R₅, R₆ are C₁ to C₅ aliphatic groups;

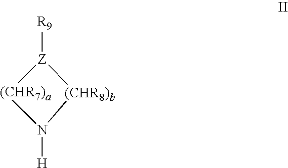

where Z=N, O, S
R₇ and R₈ are hydrogen or C₁ to C₅ aliphatic groups,
R₉ is C₁ to C₅ aliphatic group when Z=N,
a=2 or 3, b=1-3;

wherein the chain terminating agent (d) is contacted with the other reactants after (a), (b), and (c) are contacted together so that the desired polyurethane structure is formed; and

wherein the moles of isocyanate groups exceeds the moles of the isocyanate reactive groups without including the non-ionic hydrophilic secondary amine isocyanate reactive amine.

The present invention also relates to aqueous dispersions comprising a continuous phase comprising water, and a dispersed phase comprising the water-dispersible urea terminated polyurethane shown above. The present invention further relates to an aqueous polyurethane composition comprising a urea-terminated polyurethane is as generally set forth above, wherein it contains a non ionic hydrophilic secondary amine and a sufficient amount of ionic functionality in order to render the polyurethane dispersible in the continuous phase of the dispersion. Preferably, the polyurethane is an ionically-stabilized polyurethane polymer.

The continuous phase of the aqueous dispersion, in addition to water, may further comprise water-miscible organic solvent. A preferred level of organic solvent is from about 0 wt % to about 30 wt %, based on the weight of the continuous phase.

The dispersed phase of the aqueous polyurethane dispersion is preferably from about 10 wt % to about 60 wt % of the total weight of the dispersion.

In another aspect, the present invention relates to the preparation of a urea terminated polyurethane dispersion composition comprising the steps of:

(a) contacting
(i) at least one diol,
(ii) at least one diisocyanate, and
(iii) at least one hydrophilic reactant selected from the group consisting of (1) mono or diisocyanate containing an ionic or ionizable group, and (2) isocyanate reactive reactant containing an ionic or ionizable group in the presence of a water-miscible organic solvent to form an isocyanate functional polyurethane prepolymer

(b) adding water to form an aqueous dispersion and

(c) prior to, concurrently with or subsequent to step (b), chain-terminating the isocyanate-functional prepolymer with a non-ionic hydrophilic secondary amine according to structure I or II or combinations of structure I and II.

The diol, diisocyanate and hydrophilic reactant may be added together in any order.

The chain terminating amine is typically added prior to addition of water in an amount to react with substantially any remaining isocyanate functionality. If the hydrophilic reactant contains ionizable groups then, at the time of addition of water (step (c)), the ionizable groups must be ionized by adding acid or base (depending on the type of ionizable group) in an amount such that the polyurethane can be stably dispersed.

Preferably, at some point during the reaction (generally after addition of water and after chain extension), the organic solvent is substantially removed under vacuum to produce an essentially solvent-free dispersion.

In general, these polyurethane dispersions are added to the formulations as a freely added material and as such behave as non-interacting resin in the formulation. Alternatively, these polyurethanes can be used as dispersants for pigments, pharmaceuticals and other small particles.

### DETAILED DESCRIPTION OF THE PREFERRED EMBODIMENTS

All publications, patent applications, patents and other references mentioned herein, if not otherwise indicated, are incorporated by reference herein for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Use of “a” or “an” are employed to describe elements and components of the invention. This is done merely for convenience and to give a general sense of the invention. This description should be read to include one or at least one and the singular also includes the plural unless it is obvious that it is meant otherwise.

The materials, methods, and examples herein are illustrative only and, except as specifically stated, are not intended to be limiting. Although methods and materials similar or equivalent to those described herein can be used in the practice or testing of the present invention, suitable methods and materials are described herein.

In one aspect, the present invention relates to a urea terminated polyurethane composition prepared from reactants comprising:

(a) at least one diol

(b) at least one diisocyanate

(c) a hydrophilic reactant selected from the group consisting of (i) mono or diisocyanate containing an ionic or ionizable group, and (ii) isocyanate reactive reactant containing an ionic or ionizable group,

(d) a non-ionic hydrophilic secondary amine chain terminating agent according to structure I or II or combinations of structure I and II,

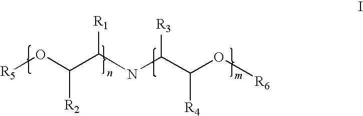

where n, m>0, n+m<10
R₁, R₂, R₃, and R₄ are hydrogen, C₁ to C₅ aliphatic groups and
R₁-R₄ can be bonded to form cyclic substituents
R₅, R₆ are C₁ to C₅ aliphatic groups;

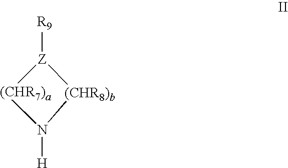

where Z=N, O, S
R₇ and R₈ are hydrogen or C₁ to C₅ aliphatic groups,
R₉ is C₁ to C₅ aliphatic group when Z=N,
a=2 or 3, b=1-3;

wherein the chain terminating is contacted with the other reactants after the (a), (b), and (c) are contacted together; and

wherein the moles of isocyanate groups exceeds the moles of the isocyanate reactive groups without including the non-ionic hydrophilic secondary amine isocyanate reactive amine.

The present invention also relates to aqueous dispersions comprising a continuous phase comprising water, and a dispersed phase comprising the water-dispersible urea terminated polyurethane shown above. The present invention further relates to an aqueous polyurethane composition comprising a urea-terminated polyurethane is as generally set forth above, wherein it contains a non ionic hydrophilic secondary amine and a sufficient amount of ionic functionality in order to render the polyurethane dispersible in the continuous phase of the dispersion. Preferably, the polyurethane is an ionically-stabilized polyurethane polymer.

The continuous phase of the aqueous dispersion, in addition to water, may further comprise water-miscible organic solvent. A preferred level of organic solvent is from about 0 wt % to about 30 wt %, based on the weight of the continuous phase.

The dispersed phase of the aqueous polyurethane dispersion is preferably from about 10 wt % to about 60 wt % of the total weight of the dispersion.

In another aspect, the present invention relates to a the preparation of a urea terminated polyurethane dispersion composition comprising the steps of:

(a) contacting
(i) at least one diol,
(ii) at least one diisocyanate, and
(iii) at least one hydrophilic reactant selected from the group consisting of (1) mono or diisocyanate containing an ionic or ionizable group, and (2) isocyanate reactive reactant containing an ionic or ionizable group in the presence of a water-miscible organic solvent to form an isocyanate functional polyurethane prepolymer

(b) adding water to form an aqueous dispersion and

(c) prior to, concurrently with or subsequent to step (b), chain-terminating the isocyanate-functional prepolymer with a non-ionic hydrophilic secondary amine according to structure I or II or combinations of structure I and II.

The diol, diisocyanate and hydrophilic reactant may be added together in any order.

The chain terminating amine is typically added prior to addition of water in an amount to react with substantially any remaining isocyanate functionality If the hydrophilic reactant contains ionizable groups then, at the time of addition of water (step (c)), the ionizable groups must be ionized by adding acid or base (depending on the type of ionizable group) in an amount such that the polyurethane can be stably dispersed.

Preferably, at some point during the reaction (generally after addition of water and after chain extension), the organic solvent is substantially removed under vacuum to produce an essentially solvent-free dispersion.

If the hydrophilic reactant contains ionizable groups then, at the time of addition of water (step (c)), the ionizable groups must be ionized by adding acid or base (depending on the type of ionizable group) in an amount such that the polyurethane can be stably dispersed.

Preferably, at some point during the reaction (generally after addition of water and after chain extension), the organic solvent is substantially removed under vacuum to produce an essentially solvent-free dispersion.

### Chain Termination Reactant.

The terminating agent is a non ionic hydrophilic secondary amine which is added to make the urea termination. Structure (I) and (II) denote the non ionic hydrophilic secondary amine. The amine nitrogen is meant to react with the excess isocyanato groups to form a urea terminated polyurethane. The alkyl substituted ether, R₅ and R₆ does not have a site for further reaction with the isocyanate groups. While not being bound by theory it is believed that the —O—CH₂—CH₂— group imparts additional hydrophilic behavior to the polyurethane. Furthermore, the terminating position of this nonionic substitute on the polyurethane could impart additional advantages for these urea terminated polyurethanes.

The amount of chain terminator employed should be approximately equivalent to the free isocyanate groups in the prepolymer, The ratio of active hydrogens in the non ionic hydrophilic secondary amine to isocyanate groups in the prepolymer preferably being in the range from about 1.0:1 to about 1.2:1, more preferably from about 1.0:1.1 to about 1.1:1, and still more preferably from about 1.0:1.05 to about 1.1:1, on an equivalent basis. Although any isocyanate groups that are not terminated with an amine can react with water the ratio of non ionic hydrophilic secondary amine to isocyanate group is chosen to assure a urea termination. Amine termination of the polyurethane is avoided by the choice and amount of non ionic hydrophilic secondary amine which leads to a urea terminated polyurethane. This polyurethane has better controlled molecular weight and better properties when freely added to formulations and as a particle dispersant.

Secondary amines (see structure I, II) reactive with isocyanates may be used as chain terminators. A more preferred isocyanate reactive chain terminator is bis(methoxyethyl)amine. Other non ionic hydrophilic secondary amines include heterocyclic structures such as morpholine and similar secondary nitrogen heterocycles. This nonionic hydrophilic group preferably provides the urea terminated polyurethane with more water compatibility.

A substitution pattern for the nonionic hydrophilic secondary amine for Structure (I) has n and m are 1 and R₁, R₂, R₃, and R4, are methyl or hydrogen. An alternative substitution pattern for Structure (I) has n and m are 1 and R₁, R₂, R₃, and R4, are hydrogen. The bis(methoxyethyl amine {where for Structure (I) n and m are 1; R₁, R₂, R₃, and R4, are methyl or hydrogen; and R₅ and R₆ are methyl} is part of a preferred class of urea terminating reactant where the substituents are non reactive in the isocyanate chemistry, but are nonionic hydrophilic groups. The substitution pattern for Structure (II) has a and b are 2; R₈, and R9, are hydrogen; and Z is oxygen.

The urea content in percent of the polyurethane is determined by dividing the mass of non ionic hydrophilic secondary amine by the sum of the other polyurethane components including the non ionic hydrophilic secondary amine agent. The urea content will be from about 0.75 wt % to about 14.5 wt %. The urea content will be preferably from about 1.5 wt % to about 13.5 wt %. The urea content will be preferably from about 2.0 wt % to about 12.5 wt %.

### Polyisocyanate Component

Suitable polyisocyanates are those that contain either aromatic, cycloaliphatic or aliphatic groups bound to the isocyanate groups. Mixtures of these compounds may also be used. Preferred are compounds with isocyanates bound to a cycloaliphatic or aliphatic moieties. If aromatic isocyanates are used, cycloaliphatic or aliphatic isocyanates are preferably present as well. R₁ can be preferably substituted with aliphatic groups.

Diisocyanates are preferred, and any diisocyanate useful in preparing polyurethanes and/or polyurethane-ureas from polyether glycols, diisocyanates and diols or amine can be used in this invention.

Examples of suitable diisocyanates include, but are not limited to, 2,4-toluene diisocyanate (TDI); 2,6-toluene diisocyanate; trimethyl hexamethylene diisocyanate (TMDI); 4,4′-diphenylmethane diisocyanate (MDI); 4,4′-dicyclohexylmethane diisocyanate (H₁₂MDI); 3,3′-dimethyl-4,4′-biphenyl diisocyanate (TODD; Dodecane diisocyanate (C₁₂DI); m-tetramethylene xylylene diisocyanate (TMXDI); 1,4-benzene diisocyanate; trans-cyclohexane-1,4-diisocyanate; 1,5-naphthalene diisocyanate (NDI); 1,6-hexamethylene diisocyanate (HDI); 4,6-xylyene diisocyanate; isophorone diisocyanate (IPDI); and combinations thereof. IPDI and TMXDI are preferred.

Small amounts, preferably less than about 3 wt % based on the weight of the diisocyanate, of monoisocyanates or polyisocyanates can be used in mixture with the diisocyanate. Examples of useful monoisocyanates include alkyl isocyanates such as octadecyl isocyanate and aryl isocyanates such as phenyl isocyanate. Example of a polyisocyanate are triisocyanatotoluene HDI trimer (Desmodur 3300), and polymeric MDI (Mondur MR and MRS).

### Diol Component

Suitable higher molecular weight diols or polyols containing at least two hydroxy groups, which may be reacted with the preadducts to prepare the NCO prepolymers, are those having a molecular weight of about 200 to about 6000, preferably about 600 to about 3000, and more preferably about 800 to about 2500. The molecular weights are number average molecular weights (Mn) and are determined by end group analysis (OH number, hydroxyl analysis). Examples of these high molecular weight compounds include polyether polyols, polyester polyols, polyester polycarbonate polyols, polyhydroxy, polycarbonates, polyhydroxy polyacetals, polyhydroxy polyacrylates, polyhydroxy polyester amides and polyhydroxy polythioethers. A combination of the diols can also be used in the polyurethane.

The preferred polyol is a diol. Examples of these high molecular weight compounds include polyether diols, polyester diols, polyester polycarbonate diols, polycarbonates diols, polyacetals diols polyacrylates diols, polyester amides diols and polythioethers diols. Mixtures of different diols and/or polyols may be used.

Suitable polyether polyols are obtained in known manner by the reaction of starting compounds which contain reactive hydrogen atoms with alkylene oxides such as ethylene oxide, propylene oxide, butylene oxide, styrene oxide, tetrahydrofuran, epichlorohydrin or mixtures of these alkylene oxides. It is preferred that the polyethers do not contain more than about 10% by weight of ethylene oxide units. Most preferably, polyethers obtained without the addition of ethylene oxide are used. Suitable starting compounds containing reactive hydrogen atoms include the polyhydric alcohols set forth for preparing the polyester polyols and, in addition, water, methanol, ethanol, 1,2,6-hexane triol,1,2,4-butane triol,trimethylol ethane, pentaerythritol, mannitol, sorbitol, methyl glycoside, sucrose, phenol, isononyl phenol, resorcinol, hydroquinone, 1,1,1- or 1,1,2-tris-(hydroxylphenyl)ethane.

Diol component can either be based on alpha, omega dialcohol with at least 3 methylene groups and less than or equal to 30 methylene groups between the two hydroxyl groups. Oligomers of these alpha, omega dialcohol are also candidate polyethers for the inventive polyurethane. Particularly preferred diols and polyether diols are those derived from 1, 3 and 1,4 diols. A preferred polyether diol is derived from 1,3-propanediol (PO3G). The employed PO3G may be obtained by any of the various well known chemical routes or by biochemical transformation routes. Preferably, the 1,3-propanediol is obtained biochemically from a renewable source (“biologically-derived” 1,3-propanediol). The description of this biochemically obtained 1,3-propanediol can be found co-owned and co-pending U.S. patent application Ser. No. 11/782,098 (filed Jul. 24, 2007), the disclosure of which is incorporated by reference herein for all purposes as if fully set forth

Polyethers which have been obtained by the reaction of starting compounds containing amine compounds can also be used, but are less preferred for use in the present invention. Examples of these polyethers as well as suitable polyhydroxy polyacetals, polyhydroxy polyacrylates, polyhydroxy polyester amides, polyhydroxy polyamides and polyhydroxy polythioethers are disclosed in U.S. Pat. No. 4,701,480, which is incorporated by reference herein for all purposes as if fully set forth.

Suitable polyester diols include reaction products of polyhydric, preferably dihydric alcohols to which trihydric alcohols may be added and polybasic, preferably dibasic carboxylic acids. Instead of these polycarboxylic acids, the corresponding carboxylic acid anhydrides or polycarboxylic acid esters of lower alcohols or mixtures thereof may be used for preparing the polyesters. The polycarboxylic acids may be aliphatic, cycloaliphatic, aromatic and/or heterocyclic and they may be substituted, for example, by halogen atoms, and/or unsaturated. The following are mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include, e.g., enthylene glycol; propylene glycol-(1,2) and -(1,3); butylene glycol-(1,4) and -(1,3); hexanediol-(1,6); octanediol-(1,8); neopentyl glycol; cyclohexanedimethanol (1,4-bis-hydroxymethyl-cyclohexane); 2-methyl-1,3-propanediol; 2,2,4-trimethyl-1,3-pentanediol; triethylene glycol; tetra-ethylene glycol; polyethylene glycol; dipropylene glycol; polypropylene glycol; dibutylene glycol and polybutylene glycol, glycerine and trimethylol-propane. The polyesters may also contain a portion of carboxyl end groups. Polyesters of lactones, for example, epsilon-caprolactone, or hydroxycarboxylic acids, for example, omega-hydroxycaproic acid, may also be used.

Polycarbonates containing hydroxyl groups include those known, per se, such as the products obtained from the reaction of diols such as propanediol-(1,3), butanediol-(1,4) and/or hexanediol-(1,6), diethylene glycol, triethylene glycol or tetraethylene glycol with phosgene, diarylcarbonates such as diphenylcarbonate or with cyclic carbonates such as ethylene or propylene carbonate. Also suitable are polyester carbonates obtained from the above-mentioned polyesters or polylactones with phosgene, diaryl carbonates or cyclic carbonates.

Poly(meth)acrylates containing hydroxyl groups include those common in the art of addition polymerization such as cationic, anionic and radical, polymerization and the like. Preferred are alpha-omega diols. An example of these type of diols are those which are prepared by a “living” or “control” or chain transfer polymerization processes which enables the placement of one hydroxyl group at or near the termini of the polymer. U.S. Pat. No. 6,248,839 and U.S. Pat. No. 5,990,245 (both incorporated by reference herein for all purposes as if fully set forth) have examples of protocol for making terminal diols.

Polyhydroxy polyester amides containing at least two hydroxyl groups may also be used as the diol. An example of monomer that could be used to make these polyester amides is 1,3-Bis(2-hydroxyethyl)-dimethylhydantoin. This hydantoin diol may be used as a diol to prepare the inventive polyurethanes.

The high molecular weight polyols are generally present in the polyurethanes in an amount of at least about 5%, preferably at least about 10% by weight, based on the weight of the polyurethane. The maximum amount of these polyols is generally about 85%, and preferably about 75% by weight, based on the weight of the polyurethane.

### Ionic Reactants

The hydrophilic reactant contains ionic and/or ionizable groups (potentially ionic groups). Preferably, these reactants will contain one or two, more preferably two, isocyanate or isocyanate reactive groups, as well as at least one ionic or ionizable group. In the structural description of the urea terminated polyether polyurethane described herein the reactant containing the ionic group is designated as Z₂.

Examples of ionic dispersing groups include carboxylate groups (—COOM), phosphate groups (—OPO₃ M₂), phosphonate groups (—PO₃ M₂), sulfonate groups (—SO₃ M), quaternary ammonium groups (—NR₃Y, wherein Y is a monovalent anion such as chlorine or hydroxyl), or any other effective ionic group. M is a cation such as a monovalent metal ion (e.g., Na⁺, K⁺, Li⁺, etc.), H⁺, NR₄⁺, and each R can be independently an alkyl, aralkyl, aryl, or hydrogen. These ionic dispersing groups are typically located pendant from the polyurethane backbone.

The ionizable groups in general correspond to the ionic groups, except they are in the acid (such as carboxyl COOH) or base (such as primary, secondary or tertiary amine —NH₂, —NRH, or —NR₂) form. The ionizable groups are such that they are readily converted to their ionic form during the dispersion/polymer preparation process as discussed below.

The ionic or potentially ionic groups are chemically incorporated into the polyurethane in an amount to provide an ionic group content (with neutralization as needed) sufficient to render the polyurethane dispersible in the aqueous medium of the dispersion. Typical ionic group content will range from about 10 up to about 210 milliequivalents (meq), preferably from about 20 to about 140 meq., per 100 g of polyurethane.

Suitable compounds for incorporating these groups include (1) monoisocyanates or diisocyanates which contain ionic and/or ionizable groups, and (2) compounds which contain both isocyanate reactive groups and ionic and/or ionizable groups. In the context of this disclosure, the term “isocyanate reactive groups” is taken to include groups well known to those of ordinary skill in the relevant art to react with isocyanates, and preferably hydroxyl, primary amino and secondary amino groups.

Examples of isocyanates that contain ionic or potentially ionic groups are sulfonated toluene diisocyanate and sulfonated diphenylmethanediisocyanate.

With respect to compounds which contain isocyanate reactive groups and ionic or potentially ionic groups, the isocyanate reactive groups are typically amino and hydroxyl groups. The potentially ionic groups or their corresponding ionic groups may be cationic or anionic, although the anionic groups are preferred. Preferred examples of anionic groups include carboxylate and sulfonate groups. Preferred examples of cationic groups include quaternary ammonium groups and sulfonium groups.

The neutralizing agents for converting the ionizable groups to ionic groups are described in the preceding incorporated publications, and are also discussed hereinafter. Within the context of this invention, the term “neutralizing agents” is meant to embrace all types of agents that are useful for converting ionizable groups to the more hydrophilic ionic (salt) groups.

In the case of anionic group substitution, the groups can be carboxylic acid groups, carboxylate groups, sulphonic acid groups, sulphonate groups, phosphoric acid groups and phosphonate groups, The acid salts are formed by neutralizing the corresponding acid groups either prior to, during or after formation of the NCO prepolymer, preferably after formation of the NCO prepolymer.

Suitable compounds for incorporating carboxyl groups are described in U.S. Pat. No. 3,479,310, U.S. Pat. No. 4,108,814 and U.S. Pat. No. 4,408,008, the disclosures of which are incorporated by reference herein for all purposes as if fully set forth. The neutralizing agents for converting the carboxylic acid groups to carboxylate salt groups are described in the preceding incorporated publications, and are also discussed hereinafter. Within the context of this invention, the term “neutralizing agents” is meant to embrace all types of agents that are useful for converting carboxylic acid groups to the more hydrophilic carboxylate salt groups. In like manner, sulphonic acid groups, sulphonate groups, phosphoric acid groups, and phosphonate groups can be neutralized with similar compounds to their more hydrophilic salt form.

Examples of carboxylic group-containing compounds are the hydroxy-carboxylic acids corresponding to the structure (HO)ₓQ(COOH)_{y} wherein Q represents a straight or branched, hydrocarbon radical containing 1 to 12 carbon atoms, x is 1 or 2 (preferably 2), and y is 1 to 3 (preferably 1 or 2).

Examples of these hydroxy-carboxylic acids include citric acid, tartaric acid and hydroxypivalic acid.

Especially preferred acids are those of the above-mentioned structure wherein x=2 and y=1. These dihydroxy alkanoic acids are described in U.S. Pat. No. 3,412,054, the disclosure of which is incorporated by reference herein for all purposes as if fully set forth. Especially preferred dihydroxy alkanoic acids are the alpha, alpha-dimethylol alkanoic acids represented by the Structure (III):

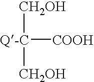

wherein Q′ is hydrogen or an alkyl group containing 1 to 8 carbon atoms. The most preferred compound is alpha, alpha-dimethylol propionic acid, i.e., wherein Q′ is methyl in the above formula. These dihydroxy alkanoic acids are described in U.S. Pat. No. 3,412,054, the disclosure of which is incorporated by reference herein for all purposes as if fully set forth. The preferred group of dihydroxy alkanoic acids are the α, α-dimethylol alkanoic acids represented by the structural structure R⁷C—(CH₂OH)₂—COOH, wherein R⁷ is hydrogen or an alkyl group containing 1 to 8 carbon atoms. Examples of these ionizable diols include but are not limited to dimethylolacetic acid, 2,2′-dimethylolbutanoic acid, 2,2′-dimethylolpropionic acid, and 2,2′-dimethylolbutyric acid. The most preferred dihydroxy alkanoic acids is 2,2′-dimethylolpropionic acid (“DMPA”). Suitable carboxylates also include H₂N— (CH₂)₄—CH(CO₂H)—NH₂, and H₂N—CH₂—CH₂—NH—CH₂—CH₂—CO₂Na

When the ionic stabilizing groups are acids, the acid groups are incorporated in an amount sufficient to provide an acid group content for the urea-terminated polyurethane, known by those skilled in the art as acid number (mg KOH per gram solid polymer), of at least about 6, preferably at least about 10 milligrams KOH per 1.0 gram of polyurethane and even more preferred at least about 20 milligrams KOH per 1.0 gram of polyurethane, The upper limit for the acid number (AN) is about 120, and preferably about 90.

These ionic groups are formed by neutralizing the corresponding potentially ionic or ionizable groups either prior to, during or after forming the polyurethane. When potentially ionic groups are neutralized prior to forming the polyurethane, the ionic groups are incorporated directly. When neutralization is preformed subsequent to forming the polyurethane, potential ionic groups are incorporated.

Suitable compounds for incorporating tertiary sulfonium groups are described in U.S. Pat. No. 3,419,533, the disclosure of which is incorporated by reference herein for all purposes as if fully set froth. The neutralizing agents for converting the potentially ionic groups to ionic groups are also described in those patents. Within the context of this disclosure, the term “neutralizing agents” is meant to embrace all types of agents which are useful for converting potentially ionic or ionizable groups to ionic groups. Accordingly, this term also embraces quaternizing agents and alkylating agents.

The preferred sulfonate groups for incorporation into the polyurethanes are the diol sulfonates as disclosed in previously incorporated U.S. Pat. No. 4,108,814. Suitable diol sulfonate compounds also include hydroxyl terminated copolyethers comprising repeat units derived from a diol and a sulfonated dicarboxylic acid and prepared as described in previously incorporated U.S. Pat. No. 6,316,586. The preferred sulfonated dicarboxylic acid is 5-sulfo-isophthalic acid, and the preferred diol is 1,3-propanediol.

Suitable sulfonates also include H₂N—CH₂—CH₂—NH—(CH₂)ᵣ—SO₃Na, where r=2 or 3; and HO—CH₂—CH₂—C(SO₃Na)—CH₂—OH. The preferred carboxylate groups for incorporation are derived from hydroxy-carboxylic acids of the general structure ((HO)ₓR⁸(COOH)_{y}, wherein R⁸ represents a straight or branched hydrocarbon radical containing 1 to 12 carbon atoms, and x and y each independently represents values from 1 to 3. Examples of these hydroxy-carboxylic acids include citric acid and tartaric acid.

In addition to the foregoing, cationic centers such as tertiary amines with one alkyl and two alkylol groups may also be used as the ionic or ionizable group.

When amines are used as the neutralizing agent, the chain terminating reaction producing the urea termination is preferably completed prior to addition of the neutralizing agent that can also behave as an isocyanate reactive group.

In order to convert the preferred potential anionic groups to anionic groups either before, during or after their incorporation into the prepolymers, either volatile or nonvolatile basic materials may be used to form the counterions of the anionic groups. Volatile bases are those wherein at least about 90% of the base used to form the counterion of the anionic group volatilizes under the conditions used to remove water from the aqueous polyurethane dispersions. Nonvolatile basic materials are those wherein at least about 90% of the base does not volatilize under the conditions used to remove water from the aqueous polyurethane dispersions.

Suitable volatile basic organic compounds for neutralizing the potential anionic groups are the primary, secondary or tertiary amines. Of these the trialkyl-substituted tertiary amines are preferred. Examples of these amines are trimethyl amine, triethyl amine, triisopropyl amine, tributyl amine, N,N-dimethyl-cyclohexyl amine, N,N-dimethylstearyl amine, N,N-dimethylaniline, N-methylmorpholine, N-ethylmorpholine, N-methylpiperazine, N-methylpyrrolidine, N-methylpiperidine, N,N-dimethyl-ethanol amine, N,N-diethyl-ethanol amine, triethanolamine, N-methyldiethanol amine, dimethylaminopropanol, 2-methoxyethyldimethyl amine, N-hydroxyethylpiperazine, 2-(2-dimethylaminoethoxy)-ethanol and 5-diethylamino-2-pentanone.

Suitable nonvolatile basic materials include monovalent metals, preferably alkali metal, more preferably lithium, sodium and potassium and most preferably sodium, hydrides, hydroxides, carbonates or bicarbonates. When an acid-containing diol, for example, is used as the ionic group, a relatively mild inorganic base such as NaHCO₃, Na₂(CO₃), NaAc (where Ac represents acetate), NaH₂PO₄ and the like will assist in improving the dispersion. These inorganic bases are relatively low in odor, and also tend not to be skin irritants.

When the potential cationic or anionic groups of the polyurethane are neutralized, they provide hydrophilicity to the polymer and better enable it to be stably dispersed in water. The neutralization steps may be conducted (1) prior to polyurethane formation by treating the component containing the potentially ionic group(s), or (2) after polyurethane formation, but prior to dispersing the polyurethane. The reaction between the neutralizing agent and the potential anionic groups may be conducted between about 20° C. and about 150° C., but is normally conducted at temperatures below about 100° C., preferably between about 30° C. and about 80° C., and more preferably between about 50° C. and about 70° C., with agitation of the reaction mixture. The ionic or potentially ionic group may be used in amount of about 2 to about 20 percent by weight solids.

The isocyanate reactive ionic reactants will preferably contain one or two; more preferably two, isocyanate reactive groups such as amino or hydroxyl groups, as well as at least one ionic or ionizable group such as carboxyl, sulfonate and tertiary ammonium salts. A preferred ionic or ionizable group is carboxyl.

### Polyurethane Dispersions

In accordance with the present invention the term “polyurethane dispersion” refers to aqueous dispersions of polymers containing urethane groups and urea groups, especially in the terminal positions of the polyurethanes, as that term is understood by those of ordinary skill in the art. These polymers also incorporate hydrophilic functionality to the extent required to maintain a stable dispersion of the polymer in water.

Preferred polyurethane dispersions are those in which the polymer is predominantly stabilized in the dispersion through incorporated ionic functionality, and particularly anionic functionality such as neutralized acid groups (“anionically stabilized polyurethane dispersion”). Further details are provided below.

Such aqueous polyurethane dispersions are typically prepared by a multi-step process in which an isocyanate (N═C═O, NCO) prepolymer is initially formed with excess isocyanate groups and these excess groups are subsequently reacted with the nonionic hydrophilic secondary amine as shown in Structure I. Also, the NCO prepolymer is typically formed by a multi-step process.

Typically, in the first stage of prepolymer formation, a diisocyanate is reacted with a compound containing one or more isocyanate-reactive groups and at least one acid or acid salt group to form an intermediate product. The molar ratio of diisocyanate to compounds containing isocyanate-reactive groups is such that the equivalents of isocyanate functionality is greater than the equivalents of isocyanate-reactive functionality, resulting in an intermediate product terminated by at least one NCO group. Thus, the molar ratio of diisocyanate to compounds containing one isocyanate-reactive group is at least about 1:1, preferably about 1:1 to about 2:1, more preferably about 1:1 to about 1.5:1 and most preferably about 1:1. The molar ratio of diisocyanate to compounds containing two isocyanate-reactive groups is at least about 1:5:1, preferably about 1.5:1 to about 3:1, more preferably about 1.8:1 to about 2.5:1, and most preferably about 2:1. Ratios for mixtures of compounds containing one and two isocyanate-reactive groups can readily be determined depending on the ratio of the two.

In general, the various ratios ensure that at least one of the isocyanate-reactive groups of the compounds containing acid groups are reacted with isocyanate groups; preferably all of the isocyanate-reactive groups are reacted with isocyanate groups from the diisocyanate.

After the preparation of the previously described intermediate product, the remaining components are reacted with the intermediate product to form the NCO prepolymer. These other components include a high molecular weight polyol, optionally an isocyanate-reactive compound containing non-ionic hydrophilic groups, These components are reacted in amounts sufficient to provide a molar ratio such that the overall equivalent ratio of isocyanate groups to isocyanate-reactive groups is about 1.1:1 to about 2:1, preferably about 1.2:1 to about 1.8:1, and more preferably about 1.2:1 to about 1.5:1.

### Polyurethane Preparation

The process of preparing the dispersions of the invention begins with preparation of the polyurethane, which can be prepared by mixture or stepwise methods. The preferred physical form of the polyurethane is as a dispersion, and as such can be easily added to formulations as a freely added polyurethane. However, these urea-terminated polyether polyurethanes can behave as a dispersant for a particle, such as a pigment. In this case, the polyurethane is either 1.) utilized as a dissolved polyurethane in a compatible solvent where the initial polyurethane/particle mixture is prepared and then processed using dispersion equipment to produce the polyurethane dispersed particle; or 2) the polyurethane dispersion and the particle dispersed are mixed in a compatible solvent system which, in turn is processed using dispersion equipment to produce the polyurethane dispersed particle. The urea terminated polyether polyurethane of the present invention may be prepared using either the mixture process or stepwise and can function as a dispersed polyurethane and a polyurethane dispersant.

The polyurethane is usually prepared by a multiple step process. Typically, in the first stage, a diisocyanate is reacted with a compound, polymer, or mixtures of compounds, mixture of polymers or a mixture thereof, each containing two NCO-reactive groups, to form a prepolymer. An additional compound or compounds, all containing ≧2 NCO-reactive groups as well as a stabilizing ionic functionality, is also used to form an intermediate polymer. The pre-polymer is an NCO-terminated material that is achieved by using a molar excess of NCO. Thus, the molar ratio of diisocyanate to compounds containing two isocyanate-reactive groups is greater than 1.0:1.0, preferably greater than about 1.05:1.0 and more preferably greater than about 1.1:1.0. In general, the ratios are achieved by preparing, in a first stage, an NCO-terminated intermediate by reacting one of the NCO-reactive compounds, having at least 2 NCO reactive groups, with all or part of the diisocyanate. This is followed, in sequence, by additions of other NCO-reactive compounds, if desired. When all reactions are complete the group, NCO will be found at the termini of the pre-polymer. These components are reacted in amounts sufficient to provide a molar ratio such that the overall equivalent ratio of NCO groups to NCO-reactive groups is achieved and the targeted urea content is obtained.

In the mixture process, isocyanate terminated polyurethane is prepared by mixing the polyol, the ionic reactant, and solvent, and then adding diisocyanate to the mixture. This reaction is conducted at from about 40° C. to about 100° C. and more preferably from about 50° C. to about 90° C. The preferred ratio of isocyanate to isocyanate reactive groups is from about 1.3:1 to about 1.05:1, and more preferably from about 1.25:1 to about 1.1:1. When the targeted percent isocyanate is reached, then the nonionic hydrophilic secondary amine chain terminator is added, and then base or acid is added to neutralize ionizable moieties incorporated from the ionizable reagent. The polyurethane solution is then converted to an aqueous polyurethane dispersion via the addition of water under high shear. If present, the volatile solvent is distilled under reduced pressure.

If some cases, addition of neutralization agent, preferably tertiary amines, may be beneficial added during early stages of the polyurethane synthesis. Alternately, advantages may be achieved via the addition of the neutralization agent, preferably alkali base, simultaneously along with the water of inversion at high shear.

In the stepwise method, isocyanate terminated polyurethane is prepared by dissolving the ionic reactant in solvent, and then adding diisocyanate to the mixture. Once the initial percent isocyanate target is reached, the polyol component is added. This reaction is conducted at from about 40° C. to about 100° C., and more preferably from about 50° C. to about 90° C. The preferred ratio of isocyanate to isocyanate reactive groups is from about 1.3:1 to about 1.05:1, and more preferably from about 1.25:1 to about 1.1:1. Alternately, the polyether polyols and up to 50% other diols may be reacted in the first step, and the ionic reactant may be added after the initial percent isocyanate target is reached. When the final targeted percent isocyanate is reached, then the chain terminator is added, and then base or acid is added to neutralize ionizable moieties incorporated from the ionizable reagent. The polyurethane solution is then converted to an aqueous polyurethane dispersion via the addition of water under high shear. If present, the volatile solvent is distilled under reduced pressure.

Catalysts are not necessary to prepare the polyurethanes, but may provide advantages in their manufacture. The catalysts most widely used are tertiary amines and organo-tin compounds such as stannous octoate, dibutyltin dioctoate, dibutyltin dilaurate.

Preparation of the polyurethane for subsequent conversion to a dispersion is facilitated by using solvent. Suitable solvents are those that are miscible with water and inert to isocyanates and other reactants utilized in forming the polyurethanes. If it is desired to prepare a solvent-free dispersion, then it is preferable to use a solvent with a high enough volatility to allow removal by distillation. However, polymerizable vinyl compounds may also be used as solvents, followed by free radical polymerization after inversion, thus forming a polyurethane acrylic hybrid dispersion. Typical solvents useful in the practice of the invention are acetone, methyl ethyl ketone, toluene, and N-methyl pyrollidone. Preferably the amount of solvent used in the reaction will be from about 10% to about 50%, more preferably from about 20% to about 40% of the weight. Alternatively, the polyurethane can be prepared in a melt with less than 5% solvent.

Process conditions for preparing the NCO containing prepolymers have been discussed in the patents and publications previously noted. The finished NCO-containing prepolymer should have a isocyanate content of about 1 to about 20%, preferably about 1 to about 10% by weight, based on the weight of prepolymer solids.

Mixtures of compounds and/or polymers having mixed NCO reactive groups are also possible.

The process conditions used for preparing the urea-terminated ether type polyurethane of the present invention generally results in a polyurethane polymer of Structure I being present in the final product. However, it is understood that the final product will typically be a mixture of products, of which a portion is the desired polyurethane polymer, the other portion being a normal distribution of other polymer products and may contain varying ratios of unreacted monomers. The heterogeneity of the resultant polymer will depend on the reactants selected and reactant conditions chosen, as will be apparent to those skilled in the art.

The acid groups are incorporated in an amount sufficient to provide an ionic group content of at least about 10, preferably at least about 18 milligrams of KOH/gram of polyurethane resin solids The upper limit for the content of acid groups is about 100, preferably about 60, and more preferably about 40 milligrams per 1 g of polyurethane resins solids. This ionic group content is equivalent to an acid number for the polyurethane resin solids.

Process conditions for preparing the NCO prepolymers have been discussed in the patents previously incorporated by reference. The finished NCO prepolymer should have a free isocyanate content of about 1 to about 20%, preferably about 1 to about 10% by weight, based on the weight of prepolymer solids.

In order to have a stable dispersion, a sufficient amount of the acid groups must be neutralized so that, when combined with the optional hydrophilic ethylene oxide units and optional external emulsifiers, the resulting polyurethane will remain stably dispersed in the aqueous medium. Generally, at least about 75%, preferably at least about 90%, of the acid groups are neutralized to the corresponding carboxylate salt groups.

Suitable neutralizing agents for converting the acid groups to salt groups either before, during or after their incorporation into the NCO prepolymers, include tertiary amines, alkali metal cations and ammonia. Examples of these neutralizing agents are disclosed in U.S. Pat. No. 4,501,852 and U.S. Pat. No. 4,701,480, both of which are incorporated by reference herein for all purposes as if fully set forth. Preferred neutralizing agents are the trialkyl-substituted tertiary amines, such as triethyl amine, tripropyl amine, dimethylcyclohexyl amine, and dimethylethyl amine.

Neutralization may take place at any point in the process. A typical procedure includes at least some neutralization of the prepolymer, which is then chain extended in water in the presence of additional neutralizing agent.

Further details about the preparation of polyurethane dispersions can be found from the previously incorporated references.

The final product is a stable aqueous dispersion of polyurethane particles having a solids content of up to about 60% by weight, preferably about 15 to about 60% by weight and most preferably about 30 to about 45% by weight. However, it is always possible to dilute the dispersions to any minimum solids content desired.

The urea terminated polyurethanes are not limited to a maximum molecular weight, especially in the case where triols or triisocyanates are used. The preferred urea terminated polyurethanes have diols and diisocyanate as the urethane components and have a molecular weight limit is 1000 to 30,000 or preferably 2000 to 20,000 reported as a number average molecular weight. During the preparation of the urea terminated polyurethane the isocyanate rich and the isocyanate amounts are controlled such that where the moles of isocyanate groups exceeds the moles of the isocyanate reactive groups without including the non-ionic hydrophilic secondary amine isocyanate reactive amine. That is, at the prepolymer state there is an excess of isocyanate groups, which in turn react with the nonionic hydrophilic secondary amine.

### Urea Terminated Polyurethane; Use in Pigmented Inks

The urea terminated polyurethane of the invention may be used in pigmented inks, which are preferably aqueous inks. During the course of studies the inventors focused on improving ink jet inks for thermal printheads. The inventive urea terminated polyurethanes with hydrophilic termini were beneficially when added to inkjet inks. Apparently, there addition reduced the coating of the thermal ink jet pen resistor. The pigment levels employed in the inks are those levels which are typically needed to impart the desired color density to the printed image. Typically, pigment levels are in the range of about 0.01 to about 10% by weight of the ink.

The polyurethane level employed is dictated by the degree of fixation sought and the range of ink properties which can be tolerated. Typically, polyurethane levels will range up to about 25%, more preferably from about 0.1 to about 20%, more typically about 0.2 to about 15%, by weight (polyurethane solids basis) of ink. The right balance of properties must be determined for each circumstance, which determination can generally be made by routine experimentation well within the skill of those of ordinary skill in the art. Normally, the urea terminated polyurethane is added after the pigment has been dispersed by dispersion processes. These pigments can be dispersed by polymeric dispersants or be self dispersed. The urea terminated polyurethanes may be used as the polymeric dispersant as well as a freely added material. Combinations of two or more polyurethane dispersions may also be utilized.

Polyurethanes dispersions may be used in combination with other binders, such as polyacrylate/polymethacrylates.

### Other Ingredients of the Pigmented Inks Containing Urea Terminated Polyurethanes

The inkjet ink may contain other ingredients as are well known in the art. For example, anionic, nonionic, cationic or amphoteric surfactants may be used. In aqueous inks, the surfactants are typically present in the amount of about 0.01 to about 5%, and preferably about 0.2 to about 2%, based on the total weight of the ink.

Co-solvents, such as those exemplified in U.S. Pat. No. 5,272,201 (incorporated by reference herein for all purposes as if fully set forth) may be included to improve pluggage inhibition properties of the ink composition. This “pluggage” is characterized by observing plugged nozzles, which results in poor print quality.

Biocides may be used to inhibit growth of microorganisms.

Sequestering agents such as EDTA may also be included to eliminate deleterious effects of heavy metal impurities.

Other known additives may also be added to improve various properties of the ink compositions as desired. For example, penetrating agents such as glycol ethers

and 1,2-alkanediols may be added to the formulation. 1,2-Alkanediols are preferably 1,2-C₁₋₆ alkanediols, most preferably 1,2-hexanediol. Other additives include 1,3-Bis(2-hydroxyethyl)-dimethylhydantoin, 2-pyrrolidone and the like.

Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether. The amount of glycol ether(s) and 1,2-alkanediol(s) added must be properly determined, but is typically in the range of from about 1 to about 15% by weight and more typically about 2 to about 10% by weight, based on the total weight of the ink.

### Ink Properties of the Inks Containing the Urea Terminated Polyurethanes

Jet velocity, separation length of the droplets, drop size and stream stability are greatly affected by the surface tension and the viscosity of the ink. Pigmented inkjet inks suitable for use with ink jet printing systems should have a surface tension in the range of about 20 mN/m (dynes/cm) to about 70 mN/m (dynes/cm), more preferably about 25 to about 40 mN/m (dynes/cm) at 25° C. Viscosity is preferably in the range of about 1 mPas (cP) to about 30 mPas (cP), more preferably about 2 to about 20 mPas (cP) at 25° C. The ink has physical properties compatible with a wide range of ejecting conditions, i.e., driving frequency of the pen and the shape and size of the nozzle. The inks should have excellent storage stability for long periods. Further, the ink should not corrode parts of the inkjet printing device it comes in contact with, and it should be essentially odorless and non-toxic. Preferred inkjet printheads include (but are not limited to) those with piezo and thermal droplet generators.

### EXAMPLES

The following examples are presented for the purpose of illustrating the invention and are not intended to be limiting. All parts, percentages, etc., are by weight unless otherwise indicated.

The dispersions whose preparation is described in the examples below were characterized in terms of their particle size and particle size distribution.

### Ingredients and Abbreviations

BMEA=bis(methoxyethyl) amine
DBTL=dibutyltindilaurate
DMEA=dimethylethanolamine
DMIPA=dimethylisopropylamine
DMPA=dimethylol propionic acid
DMBA=dimethylol butyric acid
EDA=ethylene diamine
EDTA=ethylenediamine tetraacetic acid
HDI=1,6-hexamethylene diisocyanate
IPDI=isophoronediisocyanate
TMDI=trimethylhexamethylene diisocyanate
TMXDI=m-tetramethylene xylylene diisocyanate
NMP=n-Methyl pyrolidone
TEA=triethylamine
TEOA=triethanolamine
TETA=triethylenetetramine
THF=tetrahydrofuran
Tetraglyme=Tetraethylene glycol dimethyl ether

Unless otherwise noted, the above chemicals were obtained from Aldrich (Milwaukee, Wis.) or other similar suppliers of laboratory chemicals.

Terathane® 650 is a polyether diol from Invista, Wichita, Kans.

### Extent of Polyurethane Reaction

The extent of polyurethane reaction was determined by detecting NCO % by dibutylamine titration, a common method in urethane chemistry.

In this method, a sample of the NCO containing prepolymer is reacted with a known amount of dibutylamine solution and the residual amine is back titrated with HCl.

### Particle Size Measurements

The particle size for the polyurethane dispersions, pigments and the inks were determined by dynamic light scattering using a Microtrac® UPA 150 analyzer from Honeywell/Microtrac (Montgomeryville Pa.).

This technique is based on the relationship between the velocity distribution of the particles and the particle size. Laser generated light is scattered from each particle and is Doppler shifted by the particle Brownian motion. The frequency difference between the shifted light and the unshifted light is amplified, digitalized and analyzed to recover the particle size distribution.

The reported numbers below are the volume average particle size.

### Solid Content Measurement

Solid content for the solvent free polyurethane dispersions was measured with a moisture analyzer, model MA50 from Sartorius. For polyurethane dispersions containing high boiling solvent, such as NMP, tetraethylene glycol dimethyl ether, the solid content was then determined by the weight differences before and after baking in 150° C. oven for 180 minutes.

Polyurethanes can be characterized by a variety of techniques. One technique is thermogravimetric analyses. This method characterizes thermal transitions of the polyurethanes. The initial Tg is a characteristic feature of a polyurethane. As reported in Ullman's Encylcopedia of Chemical Technology (Wiley Interscience, 1985, New York) typical T_{g} for common polyurethanes are poly(ethylene adipate)-25° C., poly(butene-1,4-adipate)-40° C.; poly (hexanediol-1-6 carbonate)-30° C. The preferred polyurethanes for the instant invention have T_{g} of less than about −30° C. Standard thermal gravimetric techniques are used to determine these glass transition temperatures.

Molecular weight is also a characteristic of the polyurethane that can be used to define a polyurethane. The molecular weight is routinely reported as weight average molecular weight, Mw. The preferred molecular weight is more than 30,000 as Mw. The polyurethane binders are not limited to Gaussian distribution of molecular weight, but may have other distributions such as bimodal distributions.

### Urea Terminated Polyurethane Example 1 IPDI/T650/DMPA AN45

A 2 L reactor was loaded with 136.7 g Terathane® 650, 84.3 g tetraethylene glycol dimethyl ether, and 32.1 g dimethylol proprionic acid. The mixture was heated to 110° C. with N₂ purge for 1 hr. Then the reaction was cooled to 80° C., and 0.3 g dibutyl tin dilaurate was added. Over 30 minute's 108.9 g isophorone diisocyanate was added followed by 28.2 g tetraethylene glycol dimethyl ether. The reaction was held at 80° C. for 5.5 hrs when the % NCO was below 1.6%. Then, 11.9 g bis(2-methoxy ethyl)amine was added over 5 minutes. After 2 hr at 80° C., the polyurethane solution was inverted under high speed mixing by adding a mixture of 45% KOH (22.8 g) and 320 g water followed by an additional 361.5 g water. The polyurethane dispersion had a viscosity of 20.6 cPs, 23.7% solids, particle size of d50=14 nm and d95=18 nm, and molecular weight by GPC of Mn 6320, Mw 17000, and Pd 2.7. The urea content is 4.1%.

### Urea Terminated Polyurethane Example 2 IPDI/T650/DMPA AN30

A 2 L reactor was loaded with 154.3 g Terathane® 650, 95.2 g tetraethylene glycol dimethyl ether, and 20.4 g dimethylol proprionic acid. The mixture was heated to 110° C. with N₂ purge for 10 min. Then the reaction was cooled to 80° C., and 0.4 g dibutyl tin dilaurate was added. Over 30 minute's 96.0 g isophorone diisocyanate was added followed by 24.0 g tetraethylene glycol dimethyl ether. The reaction was held at 80° C. for 2 hrs when the % NCO was below 1.2%. Then, 10.6 g bis(2-methoxy ethyl)amine was added over 5 minutes. After 2 hr at 80° C., the polyurethane solution was inverted under high speed mixing by adding a mixture of 45% KOH (16.8 g) and 236 g water followed by an additional 467 g water. The polyurethane dispersion had a viscosity of 11.4 cPs, 25.3% solids, particle size of d50=22 nm and d95=35 nm, and molecular weight by GPC of Mn 6520, Mw 16000, and Pd 2.5. The urea content is 8.8%.

### Urea Terminated Polyurethane Example 3: IPDI/1000 PO₃G/DMPA AN25

A 2 L reactor was loaded with 245.4 g PO3G (1075 MW) and heated to 110° C. under vacuum until contents had less than 600 ppm water. Then, added 170 g tetraethylene glycol dimethyl ether, and 22.4 g dimethylol proprionic acid. The reactor was cooled to 60° C., and 0.36 g dibutyl tin dilaurate was added. Over 1 hour, 96.7 g isophorone diisocyanate was feed in followed by 21.5 g tetraethylene glycol dimethyl ether. The reaction was held at 80° C. for 2 hrs when the % NCO was below 0.9%. The reaction was cooled to 50° C., and then, 35.3 g of 30 wt. % bis(methoxyethyl)amine in water was added over 5 minutes. After 0.5 hr at 60° C., the polyurethane solution was inverted under high speed mixing by adding a mixture of 45% KOH (18.8 g) and 262.5 g water followed by an additional 631.6 g water. The polyurethane dispersion had a viscosity of 13 cPs, 25.5% solids, and particle size of d50=35 nm and d95=47 nm. The urea content is 2.8%.

### Urea Terminated Polyurethane Example 4 IPDI/500 PO₃G/DMPA AN20

A 2 L reactor was loaded with 214.0 g PO3G (545 MW), 149.5 g tetraethylene glycol dimethyl ether, and 18.0 g dimethylol proprionic acid. The mixture was heated to 110° C. under vacuum until contents had less than 500 ppm water. Then the reaction was cooled to 50 C, and 0.24 g dibutyl tin dilaurate was added. Over 30 minute's 128.9 g isophorone diisocyanate was added followed by 21.2 g tetraethylene glycol dimethyl ether. The reaction was held at 80 C for 3 hrs when the % NCO was below 1.1%. The reaction was cooled to 50° C., and then, 14.1 g bis(2-methoxy ethyl) amine was added over 5 minutes. After 1 hr at 60° C., the polyurethane solution was inverted under high speed mixing by adding a mixture of 45% KOH (15.1 g) and 211.2 g water followed by an additional 727.8 g water. The polyurethane dispersion had a viscosity of 7.86 cPs, 25.5% solids, and particle size of d50=47 nm and d95=72 nm. The urea content is 3.8%.

### Urea Terminated Polyurethane Example 5 TDI/500 PO₃G/DMPA AN30

A 2 L reactor was loaded with 166.4 g PO3G (545 MW), 95.8 g tetraethylene glycol dimethyl ether, and 21.2 g dimethylol proprionic acid. The mixture was heated to 110° C. under vacuum until contents had less than 400 ppm water; approximately 3.5 hrs. Then the reaction was cooled to 70 C, and over 30 minutes, 89.7 g Toluene diisocyanate was added followed by 15.8 g tetraethylene glycol dimethyl ether. The reaction was held at 80° C. for 2 hrs when the % NCO was below 1.5%. Then, 12.4 g bis(2-methoxy ethyl)amine was added over 5 minutes. After 1 hr, removed 50 g for analysis. The remaining polyurethane solution was inverted under high speed mixing by adding a mixture of 45% KOH (15.5 g) and 218.0 g water followed by an additional 464 g water. The polyurethane dispersion had a viscosity of 17.6 cPs, 22.9% solids, particle size of d50=16 nm and d95=35 nm, and molecular weight by GPC of Mn 7465, Mw 15500, and Pd 2.08. The urea content is 4.3%.

### Urea Terminated Polyurethane Example 6 MDI/500 PO3G/DMPA AN30

The preparation was identical to Polyurethane Example 5 except methylene diphenyl diisocyanate was used instead of toluene diisocyanate and the formulation was adjusted for molecular weight differences in order to maintain the same NCO/OH ratio. The polyurethane dispersion had a viscosity of 23.5% solids, 34 cPs, particle size of d50=18 nm and d95=23 nm, and molecular weight by GPC of Mn 11692, Mw 29141, and Pd 2.49. The urea content is 3.7%.

### Urea Terminated Polyurethane Example 7 IPDI/500 PO3G/DMPA AN30

The preparation was identical to Polyurethane Example 5 except isophorone diisocyanate was used instead of toluene diisocyanate and the formulation was adjusted for molecular weight differences in order to maintain the same NCO/OH ratio. The polyurethane dispersion had a viscosity of 24.4% solids, 22.1 cPs, particle size of d50=nm and d95=nm, and molecular weight by GPC of Mn 8170, Mw 18084, and Pd 2.21. The urea content is 4.2%.

### Urea Terminated Polyurethane Example 8 IPDI/1500 PO3G/DMPA AN30

A 2 L reactor was loaded with 194.3 g PO3G (1516 MW), 95.8 g tetraethylene glycol dimethyl ether, and 21.0 g dimethylol proprionic acid. The mixture was heated to 110° C. under vacuum until contents had less than 400 ppm water; approximately 3.5 hrs. Then the reaction was cooled to 70 C, and over 30 minutes, 69.6 g m-isophorone diisocyanate was added followed by 11.6 g tetraethylene glycol dimethyl ether. The reaction was held at 80° C. for 4.5 hrs when the % NCO was below 1.1%. Then, 7.6 g bis(2-methoxy ethyl)amine was added over 5 minutes. After 1 hr, removed 50 g for analysis. The remaining polyurethane solution was inverted under high speed mixing by adding a mixture of 45% KOH (15.4 g) and 216 g water followed by an additional 478 g water. The polyurethane dispersion had a viscosity of 8.8 cPs, 23.2% solids, particle size of d50=12 nm and d95=23 nm, and molecular weight by GPC of Mn 8848, Mw 19048, and Pd 2.15. The urea content is 2.6%.

### Urea Terminated Polyurethane Example 9 TMXDI/T1000/DMPA AN30

A 2 L reactor was loaded with 221.6 g Terathane 1000 (977 MW), 127.5 g tetraethylene glycol dimethyl ether, and 27.0 g dimethylol proprionic acid. The mixture was heated to 110° C. under vacuum for 1 hour. Then the reaction was cooled to 90° C., and 0.32 g dibutyl tin dilaurate was added. Over 30 minute's 115 g m-Tetramethylene xylylene diisocyanate was added followed by 18.9 g tetraethylene glycol dimethyl ether. The reaction was held at 90° C. for 2 hrs when the % NCO was below 0.7%. Then, 11.4 g bis(2-methoxy ethyl)amine was added over 5 minutes. After 1 hr, the polyurethane solution was inverted under high speed mixing by adding a mixture of 45% KOH (22.6 g) and 316 g water followed by an additional 640 g water. The polyurethane dispersion was 25% solids with mean particle size of d50=34 nm and d95=48 nm. The urea content is 3.0%.

### Urea Terminated Polyurethane Example 10 IPDI/T650/DMPA AN60

The preparation was identical to Polyurethane Example 1 except with additional dimethylol proprionic acid replacing some of the Terathane 650 to adjust the final acid number of the polyurethane to 60 mg KOH/g polymer while maintaining the same NCO/OH ratio. This polyurethane dispersion had a viscosity of 21 cPs at 24.1% solids, particle size of d50=19 nm and d95=24 nm, and molecular weight by GPC of Mn 5944.

### Urea Terminated Polyurethane Example 11

This example illustrates preparation of an organic solvent-containing aqueous polyurethane dispersion from polytrimethylene ether glycol, isophorone diisocyanate, dimethylolpropionic acid ionic reactant and bis(methoxyethyl) amine chain terminator.

A 2 L reactor was loaded with 214.0 g polytrimethylene ether glycol (Mn of 545), 149.5 g tetraethylene glycol dimethyl ether, and 18.0 g dimethylol proprionic acid. The mixture was heated to 110° C. under vacuum until contents had less than 500 ppm water. The reactor was cooled to 50° C., and 0.24 g dibutyl tin dilaurate was added. 128.9 g isophorone diisocyanate was added over thirty minutes, followed by 21.2 g tetraethylene glycol dimethyl ether. The reaction was held at 80° C. for 3 hrs, and the wt % NCO was determined to be below 1.1%. The reaction was cooled to 50° C., then 14.1 g bis(2-methoxyethyl) amine was added over 5 minutes. After 1 hr at 60° C., the polyurethane solution was inverted under high speed mixing by adding a mixture of 45% KOH (15.1 g) and 211.2 g water, followed by an additional 727.8 g water.

The resulting polyurethane had an acid number of 20 mg KOH/g solids, and the polyurethane dispersion had a viscosity of 7.86 cPs, 25.5 wt % solids, and a particle size of d50=47 nm and d95=72 nm. The urea content is 3.8%.

### Urea Terminated Polyurethane Example 12

This polyether diol was prepared in a manner similar to Example 1 with less dimethylol proprionic acid and Terathane 250 instead of Terathane 650 to adjust the final acid number of the polyurethane to 40 mg KOH/g polymer while maintaining the same NCO/OH ratio. The polyurethane solution was neutralized with TEA and inverted in water. This polyurethane dispersion had a viscosity of 25.1 cPs at 21.1% solids, particle size of d50=6.4 nm and d95=8.2 nm, and molecular weight by GPC of Mn 4301.

### Urea Terminated Polyurethane Example 13 IPDI/HD BMEA AN30

Loaded 2 L reactor with 70.9 1,6-hexane diol, 55.3 g tetraethylene glycol dimethyl ether, and 21.5 g dimethylol proprionic acid. The mixture was heated to 110° C. with N₂ purge for 30 min. Then the reaction was cooled to 80° C., and 0.5 g dibutyl tin dilaurate was added. Over 30 minute's 185.8 g isophorone diisocyanate was added followed by 45.8 g tetraethylene glycol dimethyl ether. The reaction was held at 85° C. for 2 hrs when the % NCO was below 2.1%. Then, 20.3 g bis(2-methoxy ethyl)amine was added over 5 minutes. After 1 hr at 85° C., the polyurethane solution was inverted under high speed mixing by adding a mixture of 45% KOH (15.7 g) and 222 g water followed by additional 489 g water. The polyurethane dispersion had a viscosity of 9.9 cPs, 25.3% solids, pH 8.0, particle size of d50=17 nm and d95=26 nm, and molecular weight by GPC of Mn 5611, Mw 10316, and PD 1.8.

### Urea Terminated Polyurethane Example 14 IPDI/DDD BMEA AN30

A 2 L reactor was loaded with 95.9 1,12-dodecane diol, 74.9 g tetraethylene glycol dimethyl ether, and 20.6 g dimethylol proprionic acid. The mixture was heated to 110° C. with N₂ purge for 1 hr. Then the reaction was cooled to 80° C., and 0.4 g dibutyl tin dilaurate was added. Over 30 minute's 153.5 g isophorone diisocyanate was added followed by 37.9 g tetraethylene glycol dimethyl ether. The reaction was held at 85° C. for 2 hrs when the % NCO was below 1.8%. Then, 16.9 g bis(2-methoxy ethyl)amine was added over 5 minutes. After 1 hr at 85° C., the polyurethane solution was inverted under high speed mixing by adding a mixture of 45% KOH (16.9 g) and 214 g water followed by an additional 458 g water. The polyurethane dispersion had a viscosity of 11.2 cPs, 25.4% solids, pH 7.9, particle size of d50=17 nm and d95=25 nm, and molecular weight by GPC of Mn 6640, Mw 12615, and PD 1.9.

### Urea Terminated Polyurethane Example 15 IPDI/T650/DMPA AN90

The preparation was identical to Polyurethane Example 1 except with additional dimethylol proprionic acid replacing some of the Terathane 650 to adjust the final acid number of the polyurethane to 90 mg KOH/g polymer while maintaining the same NCO/OH ratio. This polyurethane dispersion had a viscosity of 45.6 cPs at 26.2% solids, particle size of d50=19 nm and d95=22 nm, and molecular weight by GPC of Mn 6916.

### Urea Terminated Polyurethane Example 16 TMDI/T650/DMPA AN45

A 2 L reactor was loaded with 136.5 Terathane 650, 95.5 g tetraethylene glycol dimethyl ether, and 30.2 g dimethylol proprionic acid. The mixture was heated to 115° C. with N₂ purge for 60 min. Then the reaction was cooled to 80° C. Over 30 minute's 101.3 g trimethylhexamethylene diisocyanate (Vestanat TMDI) was added followed by 26.0 g tetraethylene glycol dimethyl ether. The reaction was held at 85° C. for 1.5 hrs when the % NCO was below 1.0%. Then, 11.8 g bis (2-methoxy ethyl)amine was added over 5 minutes. After 1 hr at 85° C., the polyurethane solution was inverted under high speed mixing by adding a mixture of 45% KOH (25 g) and 349 g water followed by an additional 349 g water. The polyurethane dispersion had a viscosity of 20.3 cPs, 25.2% solids, and particle size of d50=16 nm and d95=20 nm.

### Urea Terminated Polyurethane Example 17 TMDI/T650/DMPA AN30

A 2 L reactor was loaded with 155.0 Terathane 650, 101.9 g tetraethylene glycol dimethyl ether, and 19.9 g dimethylol proprionic acid. The mixture was heated to 115° C. with N₂ purge for 30 min. Then the reaction was cooled to 80° C. Over 30 minute's 90.3 g trimethylhexamethylene diisocyanate (Vestanat TMDI) was added followed by 22.3 g tetraethylene glycol dimethyl ether. The reaction was held at 85° C. for 5.5 hrs when the % NCO was below 1.0%. Then, 10.5 g bis (2-methoxy ethyl)amine was added over 5 minutes. After 1 hr at 85° C., the polyurethane solution was inverted under high speed mixing by adding a mixture of 45% KOH (16.3 g) and 229 g water followed by an additional 448 g water. The polyurethane dispersion had a viscosity of 38.7 cPs, 25.0% solids, and particle size of d50=11 nm and d95=19 nm.

### Urea Terminated Polyurethane Example 18 TDI/500 PO3G/DMPA AN30

A 2 L reactor was loaded with 166.4 PO3G (545 MW, 95.8 g tetraethylene glycol dimethyl ether, and 21.2 g dimethylol proprionic acid. The mixture was heated to 110° C. under vacuum until contents had less than 400 ppm water; approximately 3.5 hrs. Then the reaction was cooled to 70 C, and over 30 minutes, 89.7 g Toluene diisocyanate was added followed by 15.8 g tetraethylene glycol dimethyl ether. The reaction was held at 80° C. for 2 hrs when the % NCO was below 1.5%. Then, 12.4 g bis(2-methoxy ethyl) amine was added over 5 minutes. After 1 hr at 60° C., removed 50 g for analysis. The remaining polyurethane solution was inverted under high speed mixing by adding a mixture of 45% KOH (15.5 g) and 218.0 g water followed by an additional 464 g water. The polyurethane dispersion had a viscosity of 17.6 cPs, 22.9% solids, particle size of d50=16 nm and d95=35 nm, and molecular weight by GPC of Mn 7465, Mw 15500, and Pd 2.08.

### Urea Terminated Polyurethane Example 19 IPDI/PPG400 BMEA AN30

A 2 L reactor was loaded with 141.5 g Polypropylene glycol 400 MW (Poly-G 20-265, OH #268, from Arch Chemical), 81.5 g tetraethylene glycol dimethyl ether, and 21.5 g dimethylol proprionic acid. The mixture was heated to 110° C. with N₂ purge for 1 hr. Then the reaction was cooled to 70° C., and 0.3 g dibutyl tin dilaurate was added. Over 30 minute's 121.9 g isophorone diisocyanate was added followed by 20.1 g tetraethylene glycol dimethyl ether. The reaction was held at 80° C. for 5 hrs when the % NCO was below 1.3%. Then, 13.3 g bis(2-methoxy ethyl)amine was added over 5 minutes. After 2 hr at 80° C., the polyurethane solution was inverted under high speed mixing by adding a mixture of 45% KOH (15.8 g) and 239 g water followed by additional 476 g water. The polyurethane dispersion had a viscosity of 25.5 cPs, 23.6% solids, pH 8.3, particle size of d50=8 nm and d95=13 nm, and molecular weight by GPC of Mn 5881, Mw 12483, and PD 2.1.

### Urea Terminated Polyurethane Example 20 IPDI/PPG1000 BMEA AN30

A 2 L reactor was loaded with 175.6 g Polypropylene glycol 400 MW (Poly-G 20-112, OH #112.7, from Arch Chemical), 101.2 g tetraethylene glycol dimethyl ether, and 20.6 g dimethylol proprionic acid. The mixture was heated to 110° C. with N2 purge for 1 hr. Then the reaction was cooled to 70° C., and 0.3 g dibutyl tin dilaurate was added. Over 30 minute's 80.7 g isophorone diisocyanate was added followed by 13.4 g tetraethylene glycol dimethyl ether. The reaction was held at 80° C. for 3.5 hrs when the % NCO was below 1.3%. Then, 8.9 g bis (2-methoxy ethyl) amine was added over 5 minutes. After 2 hr at 80° C., the polyurethane solution was inverted under high speed mixing by adding a mixture of 45% KOH (15.1 g) and 220 g water followed by additional 448 g water. The polyurethane dispersion had a viscosity of 9.7 cPs, 24.2% solids, pH 7.5, and particle size of d50=118 nm and d95=141 nm.

### Urea Terminated Polyurethane Example 21 12IPDI/15DHE T650 BMEA 45AN 90% KOH; Use of a Mixture of Diols.

A 2 L reactor was loaded with 109.7 g Terathane® 650, 33.8 g tetraethylene glycol dimethyl ether, 6.6 g Dantocol DHE (1,3-dihydroxyethyl dimethyl hydantaoin) and 27.0 g dimethylol proprionic acid. The mixture was heated to 75° C. with N₂ purge for 20 minutes. Then, 0.4 g dibutyl tin dilaurate was added. Over 60 minute's 96.6 g isophorone diisocyanate was added followed by 8.0 g tetraethylene glycol dimethyl ether. The reaction was held at 80° C. for 4 hrs when the corrected % NCO was below 1.5%. Then, 9.7 g bis(2-methoxy ethyl) amine was added over 5 minutes. After 1 hr at 80° C., the polyurethane solution was inverted under high speed mixing by adding a mixture of 45% KOH (22.6 g) and 317 g water followed by an additional 372 g water. The urea content is 3.9%

### Preparation of Pigmented Dispersions Using the Urea Terminated Polyurethanes As Dispersants.

The pigmented dispersions used in this invention can be prepared using any conventional milling process known in the art. Most milling processes use a two-step process involving a first mixing step followed by a second grinding step. The first step comprises a mixing of all the ingredients, that is, pigment, dispersants, liquid carriers, pH adjuster and any optional additives to provide a blended “premix”. Typically all liquid ingredients are added first, followed by the dispersants and lastly the pigment. Mixing is generally done in a stirred mixing vessel and high-speed dispersers, (HSD), are particularly suitable for the mixing step. A Cowels type blade attached to the HSD and operated at 500 rpm to 4000 rpm, and preferably 2000 rpm to 3500 rpm, provides optimal shear to achieve desired mixing. Adequate mixing is achieved usually in mixing from 15 minutes to 60 minutes.

The second step comprises grinding of the premix to produce a pigmented dispersion. Preferably, grinding occurs by a media milling process although other milling techniques can be used. In this invention a lab-scale Eiger Minimill, model M250, VSE EXP from Eiger Machinery Inc. Chicago, Ill. was used. Grinding was accomplished by charging about 820 grams of 0.5 YTZ zirconia media to the mill. The mill disk speed was operated between 2000 rpm and 4000 rpm and preferably at 3000 rpm and 3500 rpm. The dispersion is processed using a re-circulation grinding process and flow rates though the mill were typically 200 to 500 grams/min. and preferably 300 grams per min. The milling may be done using a staged procedure in which a fraction of the solvent is held out of the grind and added after milling is completed. This amount of solvent held out during milling varies by dispersion and is typically 200 to 400 grams of the total 800-gram batch size. This is done to achieve optimal rheology for grinding efficiency. The invention example dispersions each were normally processed for a total of 4 hours milling time.

After completion of milling process, the dispersion was filled into a polyethylene container. Optionally, the dispersion may be further processed using conventional filtration procedures known in the art. The dispersions may be processed using ultrafiltration techniques that remove co-solvents and other contaminants, ions or impurities from the dispersion. The dispersions were tested for pH, conductivity, viscosity and particle size. To assess dispersion stability, the above properties were remeasured after oven aging of samples for 1 week at 70° C. and noting if significant change versus initial readings had occurred.

Pigmented dispersions were prepared with magenta, yellow, cyan and black pigments. For the examples in Table 1, the following pigments were used Clarient Hostaperm Pink E-02, PR-122 (Magenta), and Degussa's Nipex 180 IQ powder (Black, K).

The following procedure was used to prepare the pigment dispersions with invention dispersing resin. Using an Eiger Minimill, the premix was prepared at typically 20-30% pigment loading and the targeted dispersant level was selected at a P/D (pigment/dispersant) ratio of 1.5-3.0. Optionally, a co-solvent was added at 10% of the total dispersion formulation to facilitate pigment wetting and dissolution of the resins in premix stage and ease of grinding during milling stage. Although other similar co-solvents are suitable, triethylene glycol monobutyl ether (TEB as supplied from Dow Chemical) was the co-solvent of choice. The invention resins were pre-neutralized with either KOH or amine to facilitate solubility and dissolution into water. During the premix stage the pigment level was maintained at typically 27% and was subsequently reduced to about 24% during the milling stage by adding deionized water for optimal media mill grinding conditions. After completion of the milling stage, which was typically 4 hours, the remaining letdown of de-ionized water was added and thoroughly mixed.

All the pigmented dispersions processed with co-solvent were purified using an ultrafiltration process to remove co-solvent(s) and filter out other impurities and ions that may be present. After completion, the pigment levels in the dispersions were reduced to about 10 to 15%. A total of 6 different magenta and 3 black dispersions were prepared with the invention dispersing resins, Table 1.

### Example Pigment Dispersions

Tabulated below are pigment dispersions stabilized with polyurethane dispersants, synthesized by the method previously outlined above. The polyurethane dispersants listed refer to the Polyurethane Dispersants listed above.

The initial dispersion properties are tabulated and their one-week oven stability results are reported in Table 1 and 2, respectively. The initial particle size, viscosity, and conductivity for these dispersions were 68-144 nm, 3.1-9.8 cPs, and 0.71-2.1 mS/cm, respectively, with the pH ranging from 8.1 to 9.9. The particle size for these dispersions was stable with oven aging with a typical, mean particle size change of 20% with oven aging, but the viscosity and pH did change significantly.

TABLE 1
Pigments Dispersion Examples

| | | | Polyurethane | Particle | Vis- | |
|---|---|---|---|---|---|---|
| Pigment | Pig. | Pigment/ | Dispersant | Size | cosity | |
| Dispersion | % | Dispersant | Example | d50, nm | (cPs) | pH |
| M1 | 12.6 | 2.5 | 2 | 102 | 5.9 | 8.5 |
| M2 | 12.5 | 2.5 | 3 | 95 | 5.9 | 8.8 |
| M3 | 11.7 | 2.5 | 4 | 98 | 4.5 | 8.6 |
| M4 | 14.7 | 2.5 | 5 | 135 | 16.4 | 9.4 |
| M5 | 14.7 | 2.5 | 6 | 150 | 5.6 | 8.3 |
| M6 | 14.9 | 2.5 | 7 | 170 | 5.6 | 8.4 |
| K1 | 14.7 | 2.5 | 1 | 98 | 3.6 | 6.8 |
| K2 | 15.1 | 2.5 | 5 | 105 | 4.8 | 7.1 |
| K3 | 15 | 2.5 | 7 | 157 | 5.7 | 6.9 |
| Comp. | | | Comp. PU | NA | Gelled | NA |
| Dispersant | | | | | | |
| M | | | | | | |

In addition, a dispersion Comparative Dispersion Magenta-1 was made from the Comparative Dispersant, a diamine chain extended polyurethane dispersion. This disperant failed as a dispersant for the magenta pigment; it gelled at the pre-mix stage of the dispersion process.

TABLE 2
Pigment Dispersion Properties after Oven Aging (70° C. 1 week)

| | Particle | | |
|---|---|---|---|
| Pigment | Size | Viscosity | |
| Dispersion | nm, d₅₀ | (cPs) | pH |
| M1 | 95 | 4.0 | 8.4 |
| M2 | 120 | 5.3 | 8.9 |
| M3 | 97 | 3.1 | 9.0 |
| M4 | 158 | 15.2 | 9.3 |
| M5 | 163 | 7.2 | 8.5 |
| M6 | 165 | 6.4 | 8.8 |
| K1 | 130 | 12 | 7.0 |
| K2 | 117 | 6.7 | 7.0 |
| K3 | 171 | 13.5 | 6.8 |

### Preparation of Inks

The inks were prepared with pigmented dispersions made using invention-dispersing polymers described above, by conventional process known to the art. The pigmented dispersions were processed by routine operations suitable for inkjet ink formulation.

Typically, in preparing ink, all ingredients except the pigmented dispersion were first mixed together. After all the other ingredients were mixed, the pigmented dispersion is added. Common ingredients in ink formulations useful in pigmented dispersions include one or more humectants, co-solvent(s), one or more surfactants, a biocide, a pH adjuster, and de-ionized water.

The selected Magenta pigmented dispersions from example dispersions in Table 1 were prepared into Magenta ink formulations in which the targeted percent pigment in ink jet ink was 4.0%. Water, Polyurethane binder, Dowanol TPM, 1,2-hexanediol, ethylene glycol, Surfynol 445, and Proxel GXL were mixed with the prepared pigment dispersions in the percentages detailed in Table 3. Polyurethane binder is a crosslinked polyurethane dispersion prepared as PUD EXP1 in US 20050215663 A1, Dowanol TPM is Tripropylene glycol methyl ether from Dow Chemical, Proxel GXL is a biocide available from Avecia, Inc. and Surfynol 440 is a surfactant available from Air Products. The inks were mixed for 4 hours and then filtered through a 1 micron filtration apparatus, removing any large agglomerates, aggregates or particulates.

TABLE 3
Magenta Ink Composition

| Ink Ingredient | Weight % in Ink |
|---|---|
| 1,2 hexanediol | 7.00% |
| Dowanol TPM | 2.60% |
| Ethylene glycol | 6.3% |
| Surfynol 440 | 0.25% |
| Proxel GXL | 0.15% |
| Polyurethane binder | 4.00% |
| Pigment | 4.00% |
| Water (Balance to 100%) | Balance |

### Ink Properties

The ink properties measured were pH, viscosity, conductivity, particle size and surface tension. The particle size was measured using a Leeds and Northrup, Microtrac Ultrafine Particle Analyser (UPA). The viscosity was measured with a Brookfield Viscometer (Spindle 00, 25° C., 60 rpm). The properties of the inks prepared using example dispersions containing invention dispersing resins are reported in Table 4.

Jet velocity, drop size and stability are greatly affected by the surface tension and the viscosity of the ink. Inkjet inks typically have a surface tension in the range of about 20 dyne/cm to about 60 dyne/cm at 25° C. Viscosity can be as high as 30 cPs at 25° C., but is typically significantly lower. The inks have physical properties compatible with a wide range of ejecting conditions, i.e., driving frequency of the piezo element, or ejection conditions for a thermal head, for either a drop-on-demand device or a continuous device, and the shape and size of the nozzle. The inks of this invention should have excellent storage stability for long periods so as not clog to a significant extent in an ink jet apparatus. Further, it should not alter the materials of construction of the ink jet printing device it comes in contact with, and be essentially odorless and non-toxic.

Although not restricted to any particular viscosity range or printhead, the inventive inks are suited to lower viscosity applications such as those required by higher resolution (higher dpi) printheads that jet small droplet volumes, e.g. less than about 20 pL. Thus the viscosity (at 25° C.) of the inventive inks can be less than about 10 cPs, is preferably less than about 7 cPs, and most advantageously is less than about 5 cPs.

TABLE 4
Ink Properties of Pigmented Inks using Polyurethane Dispersants

| | | | | Particle | Surface |
|---|---|---|---|---|---|
| | | Conductivity | Viscosity | Size | Tension |
| Ink | pH | (us/cm) | (cPs) | d₅₀ | dynes/cm |
| Ink-1 from Disp M1 | 8.2 | 0.41 | 5.7 | 190 | 29.4 |
| Ink-2 from Disp M2 | 8 | 0.41 | 9.3 | 185 | 29.6 |
| Ink-3 from Disp M3 | 8 | 0.54 | 3.5 | 112 | 29.6 |
| Ink-4 from Disp M5 | 8.2 | 0.87 | 3.5 | 243 | 30 |

Print Properties: Paper Substrate

The printing of the test examples was done in the following manner unless otherwise indicated. The printing for the inks with dispersions prepared with the urea terminated polyurethanes was done on an Epson 980 printer (Epson America Inc, Long Beach, Calif.) using the black printhead which has a nominal resolution of 360 dots per inch. The printing was done in the software-selected standard print mode. The optical density and chroma were measured using a Greytag-Macbeth SpectoEye instrument (Greytag-Macbeth AG, Regensdorf, Switzerland). The DOI was measured by a Byk Gardner Wave-Scan DOI and the Gloss was measured by Byk Gardner Micro-TRI-Gloss. (Byk-Gardner, Columbia, Md.

Unless otherwise specified the ink formulation was as follows with all components as weight percent

TABLE 5
Ink Formulation

| | |
|---|---|
| Pigment | 3 |
| Dispersant | 1.2 |
| !,2-hexanediol | 4 |
| Glycerol | 10 |
| Ethylene glycol | 5 |
| 2-Pyrrolidone | 3 |
| Proxel GXL | 0.25 |
| Water (Balance to 100%) | Bal. |

Comparison of Colored Inks to Dye Inks.

Colored inks were prepared using the formulation listed in Table 5; the inventive urea terminated polyurethane dispersant used was Disp Ex 2.

TABLE 6
Inventive Inks and Commercial dye inks

| Ink | Color | Pigment | OD | DOI |
|---|---|---|---|---|
| Ink-5 | M, Magenta | R122 | 1 | 2.3 |
| Ink-6 | Y, Yellow | Y74 | 0.93 | 2.4 |
| Ink-7 | C, Cyan | PB 15:3 | 0.93 | 2.6 |
| Comp Ink 1, Dye | | | 1.15 | 2.5 |
| Comp Ink 2, Dye | | | 0.97 | 2.4 |
| Comp Ink 3, Dye | | | 1.15 | 3 |

The inventive inks as pigmented inks rival the OD and DOI the less durable dye inks.

What is claimed is:

1. An aqueous polyurethane dispersion comprising a urea terminated polyurethane composition formed from reactants comprising:
(a) at least one diol
(b) at least one diisocyanate
(c) a hydrophilic reactant selected from the group consisting of (i) mono or diisocyanate containing an ionic or ionizable group, and (ii) isocyanate reactive reactant containing an ionic or ionizable group,
(d) a non-ionic hydrophilic secondary amine chain terminating agent according to structure I or II or combinations of structure I and II, 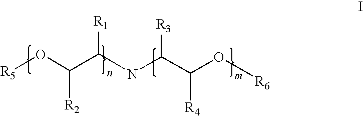
where n, m>0, n+m<10
R₁, R₂, R₃, and R₄ are hydrogen, C₁ to C₅ aliphatic groups and
R₁-R₄ can be bonded to form cyclic substituents
R₅, R₆ are C₁ to C₅ aliphatic groups; 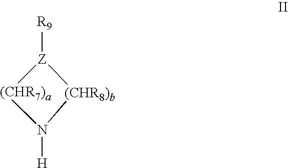
where Z=N, O, S
R₇ and R₈ are hydrogen or C₁ to C₅ aliphatic groups,
R₉ is C₁ to C₅ aliphatic group when Z=N,
a=2 or 3, b=1-3;
wherein the chain terminating agent (d) is contacted with the other reactants (a), (b) and (c) after the (a), (b), and (c) are contacted together. and
wherein the moles of isocyanate groups exceeds the moles of the isocyanate reactive groups without including the non-ionic hydrophilic secondary amine.

2. The aqueous polyurethane dispersion of claim 1 and the weight percent of the polyurethane urea content of the urea-terminated polyurethane is at least about 0.75 wt % and at most about 14.5 wt % of the polyurethane resin

3. The aqueous polyurethane dispersion of claim 1 where the content of the urea terminated polyurethane part of the polyurethane is at least 2 wt % and at most 12.5 wt %

4. The aqueous polyurethane dispersion of claim 1 where the acid number of the polyurethane is from about 10 to about 120.

5. The aqueous polyurethane dispersion of claim 1 where the acid number of the polyurethane is from about 20 to about 90.

6. The aqueous polyurethane dispersion of claim 1 where for Structure (I) n and m are 1 and R₁, R₂, R₃, and R₄, are methyl or hydrogen.

7. The aqueous polyurethane dispersion of claim 1 where for Structure (I) n and m are 1 and R₁, R₂, R₃, and R4, are hydrogen.

8. The aqueous polyurethane dispersion of claim 1 where for Structure (I) n and m are 1 and R₁, R₂, R₃, and R4, are hydrogen.

9. The aqueous polyurethane dispersion of claim 1 where for Structure (I) n and m are 1; R₁, R₂, R₃, and R4, are methyl or hydrogen; and R₅ and R6 are methyl.

10. A process for making a aqueous polyurethane dispersion comprising the steps (a) providing reactants comprising
(i) at least one diol,
ii) at least one polyisocyanate component comprising a diisocyanate, and
(iii) at least a hydrophilic reactant selected from the group consisting of (1) mono or diisocyanate containing an ionic or ionizable group, and (2) isocyanate reactive reactant containing an ionic or ionizable group,
(b) contacting (i), (ii) and (iii) in the presence of a water-miscible organic solvent to form an isocyanate-functional polyurethane prepolymer;
(c) adding water to form an aqueous dispersion; and
(d) prior to, concurrently with or subsequent to step (c), chain-terminating the isocyanate-functional prepolymer with a non-ionic hydrophilic secondary amine.
